(19) United States
(12) Patent Application Publication
(10) Pub. No.: US 2003/0184260 A1
(43) Pub. Date: Oct. 2, 2003

(54) Internal boost-off system

(76) Inventor: Lewis R. Thomas, Fort Worth, TX (US)

Correspondence Address: Lewis R. Thomas, 4241 Wiman Drive, Fort Worth, TX, 76119, US

(21) Appl. No.: 10/114,229

(22) Filed: Apr. 2, 2002

(51) Int. Cl. H02J 7/00

(52) U.S. Cl. 320/114

(57) ABSTRACT

The Internal Boost-off System is designed to be a user-friendly way to boost your car battery's power. The system can be mounted under your dashboard, in your console, under your seat, or on side of your door. The system includes a plurality of components that combine to achieve a common end. The system has several safeguards in place to promote safety and ease of use. The connection guide (45) prevents improper connection of terminals (25) to terminals (50) and terminal (55) or terminals (50a) and terminal (55a). The cable (10) that connects to the power transfer center is enclosed to avoid inadvertent conducting of metals. The Y adapter (15) affords its users an alternative location in which to connect their starter for greater access should power need to be disconnected in the event of a fire or accident. The system has an adapter that enables it to be used on non-system vehicles. It also has an adapter that lets you run several accessories off of your battery instead of connecting them to your fuse box.

### CROSS REFERENCE TO RELATED APPLICATION

Not applicable

### BACKGROUND

1. Field of Invention

This invention relates to the recharging or boosting of battery power in motorized vehicles, specifically automobiles, but not limited thereto.

2. Description of Prior Art

It has been stated that the battery is the heart of the automobile. Like many of the parts that it controls; it too eventually loses power and must be either recharged or replaced.

Boosting a battery is the most common practice for restoring power to a weak battery. This procedure is accomplished by:

(a) getting out of your vehicle

(b) raising your hood

(c) connecting the positive and negative booster cables to their respective posts

(d) repeating the process on the assisting vehicle, and

(e) then wait until your battery has enough power to start your vehicle.

This seems relatively simple. Let's examine this process a little closer.

Some of the negative factors associated with the prior art are: safety/health factors, speed, ease of use, salability, appearance, market size, seasonal demand, excitement, and satisfies existing needs.

Safety/health factors. Though it is not a frequent occurrence, battery explosions do sometimes happen. This exposes the user of the battery cables to unnecessary risk and danger. Furthermore, you cannot determine where your vehicle will breakdown. Dark roads and low populated areas are a magnet for vehicles breakdowns. Not every person that stop to assist a stranded motorist, have that person's best interest at heart.

Speed. With booster cables, the user must get out of their vehicle, raise their hood, and connect the cables to the battery. With the limited amount of space in modern vehicles, booster cable connecting has become ever more time consuming. In low visibility, connecting the proper cable to the proper post becomes even more time consuming.

Ease of use. Though boosting a battery isn't rocket science, it does present a problem to many consumers. Not every driver understands the concept of positive and negative currents.

Salability. Because some people do not know how to use booster cables, this inhibits the sale of many sets.

Market size. Difficulty in use limits the size of its current market.

Seasonal demand. Though breakdowns are not determined by seasons, most battery breakdowns during the cold season. This exposes the user to inclement weather.

Satisfies existing needs. While booster cables do recharge batteries, they can not influence factors such as weather, darkness, condition of battery, and educational level of the user.

### SUMMARY

In accordance with the current invention an Internal Boost-off system is comprised of a plurality of components combined to achieve a complete transfer of electrical current while being user friendly.

### OBJECTS AND ADVANTAGES

Accordingly, besides the objects and advantages of booster cables listed above, several objects and advantages of the present invention are:

(a) to be easily accessible

(b) to eliminate the need to get out of your vehicle (other than to find someone to assist you)

(c) to eliminate the need to raise your hood

(d) to reduce the risk of getting battery acid on yourself

(e) to offer an alternate spot in which to disconnect battery power

(f) to offer an alternative location to hookup accessories (ie., citizen band radios, amplifiers, special lights, ect.).

(g) marketability

(h) to create a renewed sense of excitement in its ease of use

Further objects and advantages are to be user friendly and convenient. When firefighters respond to motor vehicles accidents, it is standard operating procedure to disconnect the car battery in an effort to avoid a potential fire and/or explosion. Said system will give you an alternate location in which to connect your starter. More often than not in vehicle accidents, getting to the battery is nearly impossible. Still further objects and advantages will become apparent from a consideration of the ensuing description and drawings.

### DRAWING FIGURES

In the drawings, closely related figures have the same number but different alphabetic suffixes.

FIG. 1 shows the power transfer center and some attachments

FIG. 2 shows the power transfer cables

FIG. 3 shows the power transfer adapter

FIG. 4 shows the accessories adapter

REFERENCE NUMERALS IN DRAWING

| | |
|---|---|
| 10 cable | 15 Y adapter |
| 20 crimp | 25 power transfer terminal |
| 30 double-sided adhesive | 35 hole |
| 39 washer | 40 nut |
| 45 connection guide | 50 power transfer cable terminal (pos) |
| 50a power transfers | 55 power transfer cable terminal (neg.) |
| accessory terminal (pos) | |
| 60 battery cable hookup inlet | 65 rubber |
| 70 washer | 75 screw |
| 80 clasp | |

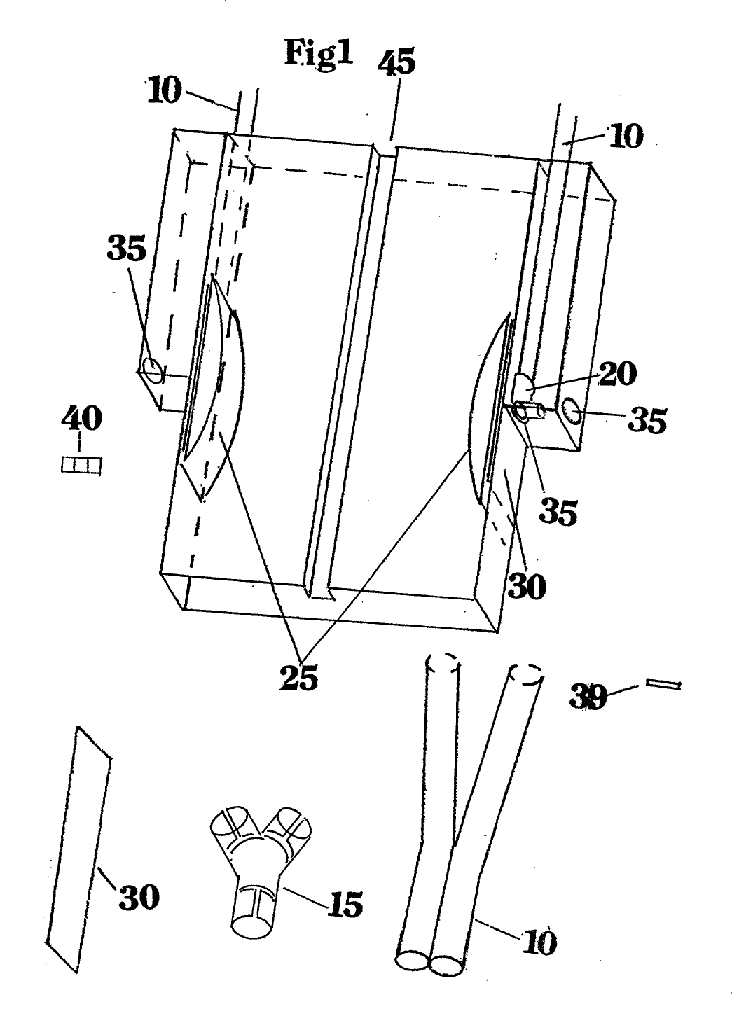

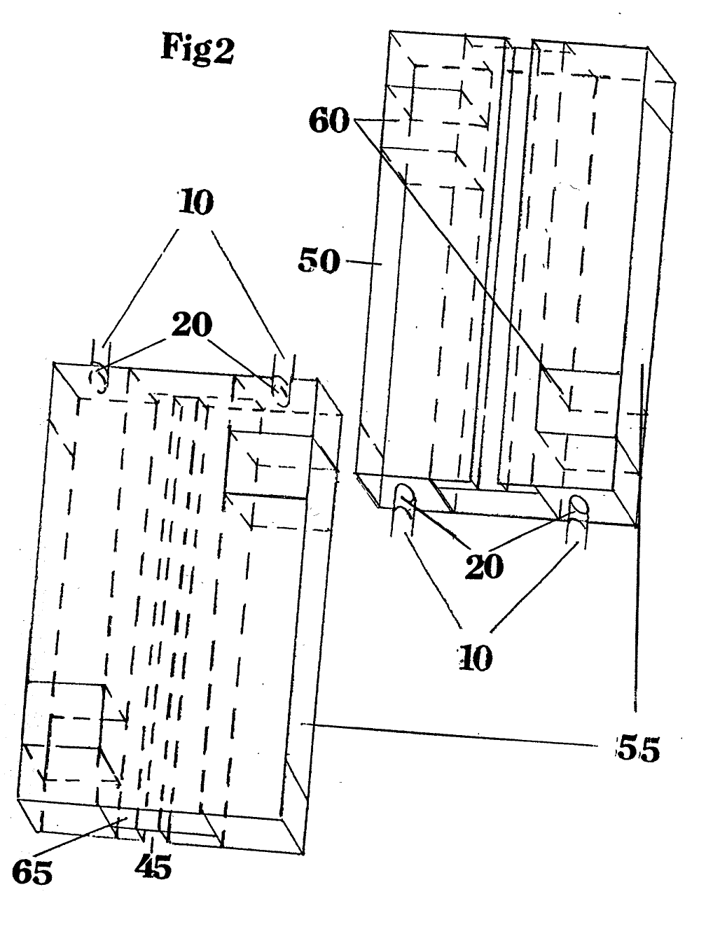

### DESCRIPTION—FIGS. 1-2—PREFERRED EMBODIMENT

A preferred embodiment of the Internal Boost-off System of the present invention is illustrated in FIG. 1 (top view) with a cable 10 originating from the battery, negative cable 10 being grounded and continuing on and attaches to a power transfer terminal 25 by a crimp 20. Positive cable 10 attaches to a Y adapter 15 and continues on to said terminal 25 mounted on the interior walls with a double-sided adhesive 30. FIG. 1 does not show the above connections in the drawing but it is identical to the drawing present.

Said terminal protrudes through a hole 35 while said crimp 20 overlays said terminal 25 bolt and is connected by a washer 39 and a nut 40 on each said terminal 25 respectfully.

FIG. 2 shows a power transfer cable set. Said transfer cables has a positive terminal 50 and negative terminal 55 housed in each casing. Each housing has a connection guide 45. Said guide 45 appears on the top of one housing and the bottom of the other. Positive terminal 50 of one housing is connected to positive terminal 50 of the other housing by said cable 10 with the use of said crimp 20 on each said terminal 50. Said terminal 55 is connected in the identical manner. Each set of said terminal 50 and said terminal 55 are divided by a rubber 65. Each said terminal 50 and said terminal 55 has a battery cable hookup inlet 60.

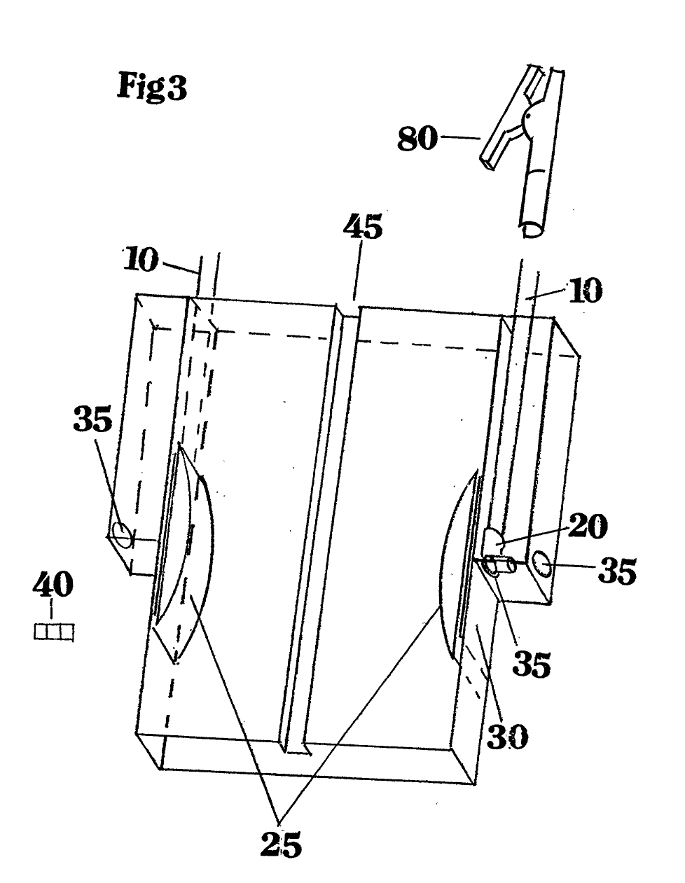

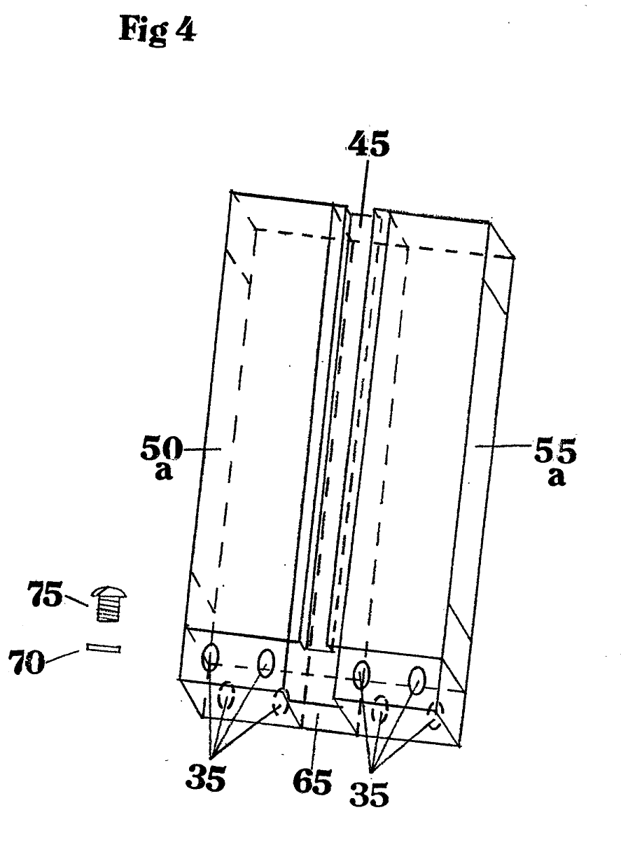

### FIGS. 3-4—ADDITIONAL EMBODIMENTS

Additional embodiments are shown in FIGS. 3 and 4; these help complete the transfer of power process. FIG. 3 shows an adapter that can be used on a battery or vehicle that does not have the Internal Boost-off System. Plug the power transfer cable FIG. 2 into the adapter. Clasp 80 attaches to the positive and negative post respectfully.

FIG. 4 shows accessories adapter that can be used to connect vehicle accessories like cell phones, CD players, extra lights, CB radios, and the like. FIG. 4 is identical to the transfer cables FIG. 2 with the exception being that the terminal 50a and 55a extend beyond the housing and have holes 35 on both the top and bottom for attaching wires to. The wires are secured with a washer 70 and screw 75. The housing in FIG. 4 also does not have battery cable hook-up inlets 60.

Advantages

From the descriptions above, a number of advantages to the Internal Boost-off System become evident:

(a) once the system is in place and connected, getting out of your car to raise your hood and connect battery cables could become obsolete.

(b) connecting your starter to the Y adapter would afford firefighters greater access to disconnecting your vehicle's power source in the event of an accident or fire.

(c) the connection guide eliminates the possibility of hooking the cables up incorrectly

(d) the accessories adapter let you hook up additional items to your battery instead of overloading your fuse box

(e) the system eliminates the chance of you getting battery acid on yourself due to a battery explosion

(f) the process of battery boosting can be expedited due to the accessibility of the unit

(g) the connection guide make the system easy to use

(h) its simplicity would make it very marketable

(i) it would not be just a seasonal piece of equipment, and

(j) it would satisfy an existing need for a more efficient, user friendly means for boosting your vehicle's battery.

Operation

The Internal Boost-off System was designed to be user friendly and that is why it comes partially assembled. I will explain the procedure for connecting the remainder of the system and how it works. To begin, take your long single cable 10 with the Y adapter 15 on it and extend it under your dashboard, out into the motor area of your vehicle. Remove the starter wire from the battery post (this wire might be coming from your solenoid) and connect the cable 10 to that post. Put the starter wire inside of your vehicle where the cable 10 comes out. You might have to splice a longer piece of wire to the starter wire. Connect this wire next to the cable 10. Extend your other cable 10 through the same hole leading out into your motor compartment and connect it to where your negative battery cable is grounded. Place the crimp 20 on top of the existing crimp from the battery.

Roll up any excess cable 10 out of your way. Place two (2) strips of double sided adhesive 30 on the back of the power transfer center FIG. 1 and position it where you want it to be stationed under your dashboard or in your console area. Your power transfer cables FIG. 2 comes pre-assembled and should be placed either under your seat or in a pocket behind you.

Your system is now functional and this is how it works. Let's assume that your vehicle's battery needs a boost. You have found someone to assist you who has an Internal Boost-off System. The assisting person could pull alongside of you or back in next to you. Either way, you would remove your power transfer cables FIG. 2 from their stored area, plug one end into your power transfer center FIG. 1 and pass the other end to the person assisting you. They in turn would plug the other end into their unit. The connection guides 45 would prevent inadvertent hookups. Start your vehicle; remove your transfer cables FIG. 2. No getting out of your vehicle or raising or lowering of your hood.

Let us assume this time that the assisting person does not have an Internal Boost-off System.

They would have to position their vehicle, then get out and raise the hood. You on the other hand would remove your transfer cables FIG. 2 and your transfer adapter FIG. 3 from their stored place. Plug one end into the transfer center FIG. 1 and the other into the transfer adapter and pass it through your window to the assisting person. They would connect the clasp 80 to their positive and negative respectfully. After you start your vehicle, they would have to disconnect the clasps 80 return them to you and then lower their hood. You on the other hand simply unplug and replace. The benefits are becoming more apparent.

Let us now assume that you have some accessories that you would like to hookup in your vehicle. For the sake of this demonstration, positive has been assigned to the left side, or terminal 50 and 50a and negative is terminal 55 and 55a. Take the positive wire of the accessory to be connected, place it under the washer 70 and tighten the screw 75 on terminal 50a. Take the negative wire and repeat the process on terminal 55a. After all accessories are connected, plug the accessories adapter FIG. 4 into the transfer center FIG. 1. Should you give someone a boost-off, you would simply unplug the adapter until the boost-off was complete then re-plug it to continue service.

In the unlikely event that your vehicle is involved in an accident and the hood is inaccessible, firefighters can disconnect your power source by removing the positive cable 10 from the top side of your Y 15. Let us flip the script and the door is inaccessible this time. The power source can be terminated at the positive battery post. To abort a possible explosion with you and/or your loved ones trapped, as a result of sparks caused by electrical currents, makes this system a near necessity!

Conclusion, Ramification, and Scope

Thus the reader sees that the Internal Boost-off System is a user friendly method for boosting off a battery without subjecting one's self to adverse weather conditions, potential threats or harm, and undue danger.

While the above description contain many specificities, these should not be construed as limitations on the scope of the invention, but rather as an exemplification of the embodiments thereof.

The figures enclosed in this packet are designs that I conceived and do not solely determine the only physical shape or design that a unit can take. Some changes that could be made in the design of certain structural members are:

(a) the shapes of various terminals used throughout;

(b) the type of materials used to construct the housing;

(c) the shape of the housing units;

(d) the anchoring process, and

(e) the installation of the power transfer units.

Irregardless of how the product looks when it makes its market debut, it will be a product that is:

(a) safety conscious

(b) quick and easy to use

(c) saleable/marketable

(d) not limited or restricted by seasons, and

(e) it satisfies an existing need

While these are not all of the ramifications and my invention should not be restricted or limited to just these, though these are the ones that come readily to mind. Thus the scope of the invention should be determined by the amended claims and their legal equivalents, rather than by the examples given.

I claim:

1. In an Internal Boost-off System of the type comprising a plurality of components interconnecting to complete a transfer of electrical current from one battery charging device or battery to another battery.

2. The system in claim 1 wherein said plurality of components are composed of lead, copper, plastic, and rubber.

3. The system in claim 1 wherein said plurality of components comprising said system: a power transfer center, a power transfer cable, an adapter for non system usage, and an accessories adapter.

4. The component in claim 3 wherein said center is rectangular in shape.

5. The component in claim 3 wherein said center is connected to a battery via a positive and negative ground cable.

6. The center in claim 5 wherein said positive ground cable is spliced with a Y adapter near the said center.

7. The center in claim 5 wherein said cables attaches to separate power transfer terminals and are with a washer and nut.

8. The center in claim 5 wherein said terminals are secured to the inside wall of said center with double-sided adhesive tape.

9. The component in claim 3 wherein said cable is rectangular in shape.

10. The component in claim 3 wherein said cable has similar housing units on each end.

11. The cable in claim 9 wherein said housing units have a connection guide cut on the top, center of one and the bottom center of the other and both go the entire length of said housing units.

12. The component in claim 10 wherein said cable attaches a positive to a positive and a negative to a negative terminal respectfully on each end.

13. The cable in claim 12 wherein said positive and negative terminals are separated by a non-electrical current conducing material on each end running the entire length of the said terminals.

14. The cable in claim 13 wherein said terminals have openings on each of them so that prior art booster cables may be connected to them.

15. The cable in claim 13 wherein said terminals will complete a transfer of electrical current when said terminal are connected to two functioning said power transfer centers.

16. The cable in claim 13 wherein said terminals will complete a transfer of electrical current when the terminal has one end connected to the power transfer center and a positive battery charging clasp and a negative battery clasp connected properly to the positive and negative openings of said terminal's other end.

17. The component in claim 3 wherein said adapter is made and responds identically to the power transfer center except that the cables on said adapter terminates with a clasp on each end of said cable.

18. The component in claim 3 wherein said adapter when each clasp is connected to a battery properly and one end of the power transfer cable is connected properly to the adapter and the other end properly connected to the power transfer center, will complete a transfer of electrical current.

19. The component in claim 3 wherein said accessories adapter is made and responds identically to a power transfer cable end with the exceptions being that the terminals are slightly longer than the housing, it has holes in them to connect accessories, and there are no cables connected to it.

20. The component in claim 3 wherein said accessories adapter will complete a transfer of electrical current when plugged into a functioning said power transfer center with a charged battery.

21. The center in claim 6 wherein said Y adapter offers an alternate place with which to attach the starter wire for ease of access should power need to be disconnected in the event of an accident or fire.
